(19) United States
(12) Patent Application Publication
(10) Pub. No.: US 2015/0212641 A1
(43) Pub. Date: Jul. 30, 2015

(54) OPERATING INTERFACE, METHOD FOR DISPLAYING INFORMATION FACILITATING OPERATION OF AN OPERATING INTERFACE AND PROGRAM

(71) Applicant: VOLKSWAGEN AG, Wolfsburg (DE)

(72) Inventors: Volkmar Tanneberger, Meine (DE); Heino Wengelnik, Wolfsburg (DE); Andreas Medler, Lengede (DE); Frank Althoff, Lehrte (DE)

(21) Appl. No.: 14/417,319

(22) PCT Filed: Jul. 22, 2013
(86) PCT No.: PCT/EP2013/065433

§ 371 Date: Jan. 26, 2015

(30) Foreign Application Priority Data
Jul. 27, 2012 (DE) 10 2012 014 910.7

(51) Int. Cl. G06F 3/041; G06F 3/0484; G06F 3/0488

(52) U.S. Cl. CPC G06F 3/0416; G06F 3/0412; G06F 3/04883; G06F 3/04842

(57) ABSTRACT

An operating interface comprising a touch-sensitive display element and at least one sensor formed to display information to a user on the display element to register touching of the display element with a touch element by the user and to register the presence of the touch element in a recognition region, the recognition region adjoining a side of the display element which faces the user. The interface also includes a control circuit formed to control the display element so the display element reproduces information facilitating operation of the operating interface on the display element when the touch element is located in the recognition region for a predetermined period of time without touching of the display element being registered during that time.

### PRIORITY CLAIM

This patent application is a U.S. National Phase of International Patent Application No. PCT/EP2013/065433, filed 22 Jul. 2013, which claims priority to German Patent Application No. 10 2012 014 910.7, filed 27 Jul. 2012, the disclosures of which are incorporated herein by reference in their entirety.

### SUMMARY

Illustrative embodiments relate to an operating interface, a method for displaying information facilitating operation of an operating interface and a program, with a program code to carry out a method of this type. These can be used, for example, to operate a multi-function system of a motor vehicle or to operate other electrical and electronic systems, for example home entertainment systems.

### BACKGROUND

The functionality of electrical and electronic components is constantly increasing in many fields of technology. Examples of this include home entertainment systems, and also multi-function systems of the type used, for example, in motor vehicles. Multi-function systems of this type may comprise, for example, functions of a navigation system, an entertainment system, a system for data networking and also the air-conditioning components of the vehicle and other vehicle-specific components.

To enable a user of these systems to operate the systems as simply and intuitively as possible, touch-sensitive display elements, which are also referred to as touchscreens, are frequently used today. Information, which may comprise, for example, virtual operating elements and other components which the user can select or activate by touching them, can be presented in a context-sensitive manner on the screens.

### BRIEF DESCRIPTION OF THE DRAWINGS

Illustrative embodiments are described and explained in detail below with reference to the attached figures.

FIG. 1 shows a front view of an operating interface according to an exemplary embodiment;

FIG. 2 shows a side view of the operating interface according to the exemplary embodiment shown in FIG. 1;

FIG. 3 shows a schematically simplified perspective view of an operating interface according to a further exemplary embodiment;

FIG. 4 shows a side view of the operating interface according to the exemplary embodiment shown in FIG. 3;

FIG. 5a shows a schematic representation of a virtual operating element;

FIG. 5b shows a schematic representation of the virtual operating element shown in FIG. 5a, which is subtly highlighted;

FIG. 5c shows the virtual operating element shown in FIGS. 5a and 5b, which is highlighted by the use of a three-dimensional representation and a luminous effect; and

FIG. 6 shows a flow diagram of a method for displaying information facilitating the operation of the operating interface.

### DETAILED DESCRIPTION OF THE DISCLOSED EMBODIMENTS

One illustrative embodiment of an operating interface comprises a touch-sensitive display element and at least one sensor which are designed to display information on the display element to a user to register a touch of the display element with a touch element by the user and to register a presence of the touch element in a detection area, wherein the detection area is adjacent to a side of the display element facing toward the user. The operating interface furthermore comprises a control circuit which is designed to control the display element in such a way that the latter presents information on the display element facilitating operation of the operating interface if the touch element is located in the detection area during a predefined time period without a touch of the display element having been registered during the time period.

A method according to at least one disclosed embodiment for displaying information facilitating operation of an operating interface comprises a display of information on a touch-sensitive display element of the operating interface, a registering of a presence of a touch element in a detection area, wherein the detection area is adjacent to a side of the display element facing toward the user, and a presentation of the information facilitating the operation of the operating interface if the touch element is located in the detection area during a predefined time period without a touch of the display element having been registered during the time period.

Illustrative embodiments similarly comprise a program with a program code for carrying out a method of this type according to a disclosed embodiment when the program code is executed on a computer, a processor or a programmable hardware component. A programmable hardware component of this type may, for example, also be a control device and a different hardware-based system of a motor vehicle.

Illustrative embodiments are therefore based on the realization that the operation of a system which a disclosed embodiment implements can thereby be facilitated and designed as more intuitive in that the latter presents information facilitating the operation when the touch element by means of which the touch-sensitive display element is operated is located in the detection area beyond the predefined time period without the display element being touched during the time period. In a situation of this type, it can be assumed, for example, that the user searches for information, a virtual operating element or a different object on the touch-sensitive display element and does not find what he actually expects there. In such a case, the user's attention can be drawn to the available possibilities and options by the corresponding presentation of the information facilitating the operation, as a result of which the operation of the operating interface can similarly be simplified and designed as more intuitive.

In addition, if an operating interface implemented in a motor vehicle is involved, the user, acting, where relevant, as the driver also, may be less distracted as a result, due to the facilitation in the operation. Traffic safety can thus, where relevant, be increased as a result.

Here, the detection area represents a volume which may be immediately adjacent to the side of the display element facing toward the user. The detection area does not therefore represent, for example, a partial area of the display element with a corresponding display surface, but extends instead perpendicular to the display surface into a spatial area through which the touch element of the user is moved to touch the display element to thus trigger or perform a corresponding action.

The control circuit can be designed to measure a time period during which the touch element is located in the detection area. On the basis of the time period defined in this way, the latter can then check whether the measured time period matches or exceeds the predefined time. If so, the control circuit can present the information facilitating the operation of the operating interface.

To control the touch-sensitive display element, the control circuit can have an information technology connection to the touch-sensitive display element. The control circuit and the touch-sensitive display element can thus enter into communication with one another via the exchange of signals comprising or carrying information. The control circuit can, for example, transmit control signals to the display element, while the touch-sensitive display element and, where relevant, the at least one sensor can transfer corresponding measurement signals and/or sensor signals to the control circuit.

Information-carrying signals can thus be transmitted, for example, by means of electrical, optical or other signals and a combination thereof. They can be exchanged by means of individual lines, but also by means of bus systems or a combination of both between the corresponding components. The information-carrying signals can be designed as continuous or discrete in terms of their signal strength and also in terms of their variation with time. The signals can thus represent, for example, analog signals, but also digital signals.

The touch-sensitive display element and the at least one sensor can optionally be designed in such a way that the detection area essentially surrounds the touch-sensitive display element completely in such a way that the touch element must pass through the detection area when the user moves the touch element toward the touch-sensitive display element. As a result, the operation of the system can, where relevant, be further simplified and designed as more intuitive, since it is thus possible, where relevant, to prevent the touch element from being guided to the display element without the control circuit not registering a pausing of the touch element in front of the display element. The operating reliability of the operating interface can thus be improved in terms of the detection of the pausing of the touch element, its responses can be designed as more reliable and thus the operation of the system can be simplified and designed as more intuitive.

In an operating interface according to a disclosed embodiment, the control circuit can optionally be designed in such a way that the predefined time period is at least 3 s. In other disclosed embodiments, the predefined time period can be at least 5 s, at least 8 s, at least 10 s or at least 15 s. As a result, it may be possible to further simplify the operation of a system of this type and design it as more intuitive in that, on the one hand, a fast movement of the touch element through the detection area does not result in a display of the information simplifying the operation, but, on the other hand, a brief pausing in the detection area is required to display the information to the user.

In an operating interface according to a disclosed embodiment, the control circuit can optionally be designed in such a way that the predefined time period is independent from a movement of the touch element in or through the detection area. The presentation of the information facilitating the operation can thus be effected more reliably, which may in turn result in a simpler and more intuitive operation of the system. In at least one disclosed embodiment of an operating interface, the manner in which the touch element moves in the detection area can in fact thus be ignored in terms of the question as to whether the information facilitating the operation is or is not presented on the display element. This may be appropriate, for example, if a movement of the touch element is disturbed, or at least affected by forces acting on the touch element. This may occur, for example in a motor vehicle, if the touch element is moved by a movement of the motor vehicle for which the user cannot or cannot completely compensate.

In an operating interface according to a disclosed embodiment, the control circuit can optionally be designed to control the display element in such a way that the display of the information facilitating the operation comprises a visual highlighting of at least one virtual operating element presented on the display element. A virtual operating element of this type may comprise, for example, a virtual button, a virtual switch, a virtual knob, a virtual slider, a virtual dial, a virtual input field, a virtual two-dimensional switch or a different corresponding virtual operating element. Depending on the specific design, an edge of the at least one virtual operating element can, for example, be highlighted with thicker and/or colored lines. Alternatively or additionally, the at least one virtual operating element can also be displayed with a color highlight. Alternatively or additionally, the operating element can similarly be displayed in a three-dimensional or enhanced three-dimensional presentation. Additionally or alternatively, the at least one virtual operating element can also be presented as pulsating and/or with a luminous effect at least partially or completely surrounding its edge.

In addition, the control circuit of an operating interface according to a disclosed embodiment can optionally be designed to control the display element in such a way that the display of the information facilitating the operation comprises a presentation of a help menu and/or a help display. Depending on the specific application situation, the user's attention can be drawn to at least one virtual operating element or a guidance of the user is enabled by the presentation of a help menu or corresponding help display. As a result, independently from the respectively implemented display of the information facilitating the operation, the operation of the system on which the operating interface according to a disclosed embodiment is based can be simplified and designed as more intuitive.

In an operating interface according to a disclosed embodiment, the control circuit can optionally be designed to make the presentation of the information facilitating the operation of the operating interface deactivatable. As a result, it may be possible, where relevant, to increase an acceptance of the user of this system, since this can influence the situations in which the corresponding information facilitating the operation is displayed. This can be done, for example, in a context-sensitive manner. Additionally or alternatively, the operation of a corresponding system can therefore, where relevant, also be simplified and designed as more intuitive through this measure.

Furthermore, in an operating interface according to a disclosed embodiment, the touch-sensitive display element and the at least one sensor can optionally be designed to register a presence of the touch element in a further detection area and the detection area, wherein the further detection area is adjacent to the detection area on a side facing toward the user. In such a case, the control circuit can furthermore be designed to control the display element in such a way that the latter presents further information facilitating the operation of the operating interface if the touch element is located in the further detection area and/or in the detection area during a further predefined time period without a touch of the display element having been registered during this time period. The detection area and the further detection area may thus, for example, form a common checking area.

In other words, the control device can be designed in such a way as to modify a presentation on the display element of information displayed on the display element. As a result, it may be possible, where relevant, already to effect a guidance of the user through this modification if the touch element is located in the further detection area adjacent to the detection area without a touch of the display element being registered during the further predefined time period. As a result of this also, the operation of a system on which the operating interface is based can thus, where relevant, be carried out more simply and more intuitively given that the modified presentation is, for example, less striking than the previously described information facilitating the operation. A two-stage presentation of corresponding information can thus be implemented. An acceptance by the user of an operating interface of this type according to a disclosed embodiment can, where relevant, also be increased as a result.

The control circuit can optionally also be designed here to check only the further detection area in connection with the further predefined time period for a presence of the touch element. A checking of the detection area can thus, where relevant, be dispensed with. In this case, the aforementioned checking area may also comprise only the further detection area which is adjacent to the detection area.

The further detection area may optionally be immediately adjacent to the detection area here. Similarly, the control circuit in turn may optionally be designed in the case of an operating interface of this type to measure the time period during which the touch element is located in the further detection area. Similarly, in the check for the presence of the touch element in the further detection area in connection with the predefined further time period, the detection area can be ignored, so that the control circuit controls the display element in such a way that the display element presents the further information facilitating the operation of the operating interface only if the touch element is located in the further detection area during the further predefined time period without a touch of the display element having been registered during this time period.

In an operating interface according to a disclosed embodiment, the touch-sensitive display element and the at least one sensor can optionally be designed in such a way that the further detection area essentially completely surrounds the detection area in such a way that the touch element must pass through the further detection area when the user moves the touch element into the detection area. As a result of this also, a more reliable operation of an operating interface can thus be enabled with regard to the further detection area, since a movement of the operating element past the further detection area is thus essentially impossible. As a result of this also, the operation of the system can thus, where relevant, be simplified and designed as more intuitive.

As already explained in connection with the detection area, in an operating interface according to a disclosed embodiment, the control circuit can in turn also be designed here optionally in such a way that the further predefined time period is at least 3 s, in disclosed embodiments at least 5 s, at least 8 s, at least 10 s or at least 15 s. As a result of this also, the operation of a corresponding system can, where relevant, be simplified and designed as more intuitive, since the presentation on the display element is modified accordingly and the further information is displayed only when the further predefined time period has elapsed. A distraction of the user can thus, where relevant, be avoided. Alternatively or additionally, where relevant, a perception of the user that he is, where relevant, also being disturbed by the modified presentation can thus also be avoided. As a result, an acceptance of an operating interface of this type can thus, where relevant, again be increased whereby the operation of the system can nevertheless be simplified and designed as more intuitive if required. The predefined time period and the further predefined time period can optionally be dimensioned here as identical, but may also be different. As a result, it may be possible, where relevant, to simplify an implementation or, depending on a distance between the touch element 150 and the display element 110, adapt a corresponding time period as from which the further information or corresponding information facilitating the operation is displayed. A separate implementation of the further predefined time period can, where relevant, also be dispensed with here.

As already explained in connection with the detection area, in an operating interface according to a disclosed embodiment, the control circuit can optionally also be designed so that the further predefined time period is independent from a movement of the touch element in or through the further detection area. As a result of this also, an operation of the system can, where relevant, be designed as simpler and more intuitive, since movements of the touch element which are caused by an unwanted movement of the touch element are, where relevant, not further taken into account.

In an operating interface according to a disclosed embodiment, the control circuit can optionally be designed to control the display element in such a way that the display of the further information facilitating the operation of the operating interface comprises a subtle highlighting of at least one virtual operating element presented on the display element. This subtle highlighting can also be effected, for example, by means of one of the aforementioned options. Alternatively or additionally, the control circuit can also be designed in such a way that it controls the display element in such a way that the display of the further information facilitating the operation of the operating interface comprises a presentation of a help menu and/or a help display. This may optionally involve the aforementioned help menu or the aforementioned help display. However, it may also be a different further help menu or different further help display. As a result of this also, a context-sensitive guidance can thus, where relevant, be enabled, as a result of which the operation of the system, where relevant, is simplified and becomes more intuitive.

In an operating interface according to a disclosed embodiment, the touch-sensitive display element and the at least one sensor can optionally be designed in such a way that the touch element comprises at least a part of a finger and/or at least a part of a hand. As a result, the operation of the system can, where relevant, be further simplified and designed as more intuitive in that a direct touch of the display element by the user is possible.

A method for displaying information facilitating operation of an operating interface can furthermore optionally comprise a measurement of a time period during which the touch element is located in the detection area without a touch of the display element being registered during the time period, as has already been explained above in connection with the operating interface. Similarly, a method according to a disclosed embodiment can furthermore comprise a registration of a touch of the touch-sensitive display element with the touch element by a user. Once the touch is registered, an action can then be triggered or performed. In the case of an implementation of an operating interface according to a disclosed embodiment, the control circuit can, for example, be designed accordingly for this purpose.

In at least one disclosed embodiment of a method of this type, the aforementioned method steps can be carried out in the indicated sequence, but also, where relevant, in a different sequence. Thus, however, individual method steps can, where relevant, be carried out simultaneously or at least temporally overlapping, unless their description or the technical context dictates otherwise.

Two objects between which no further object of the same type is arranged are adjacent here. Corresponding objects are immediately adjacent if they adjoin one another, i.e., for example, are in contact with one another. Electrical or other components are coupled with one another indirectly via a further component or directly in such a way that they enable a signal exchange between the components concerned. The corresponding coupling can thus be implemented and put into practice in sections or completely, for example electrically, optically, magnetically or by means of radio technology.

In the description of the attached figures which show illustrative embodiments, the same reference numbers denote the same or comparable components. Furthermore, summarizing reference numbers are used for components and objects which occur multiple times in a disclosed embodiment or in a drawing, but are described commonly in terms of one or more features. Components or objects which are described with the same or with summarizing reference numbers may be of identical, or, where relevant, of different design in terms of individual, some or all features, for example their dimensions, unless otherwise explicitly or implicitly evident from the description.

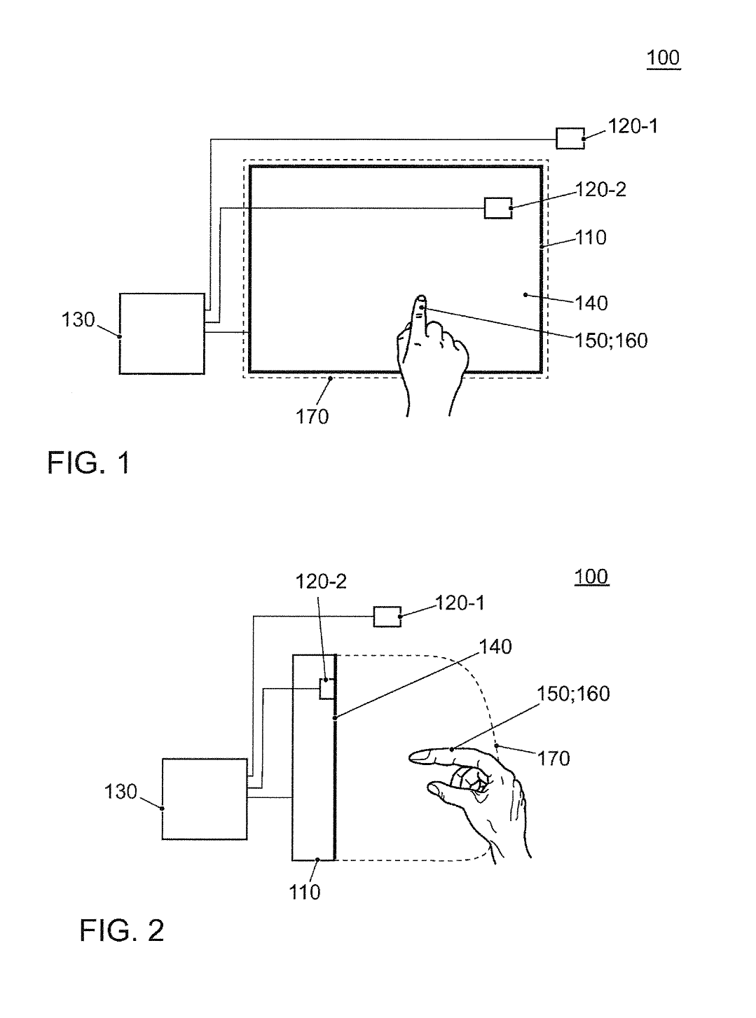

FIG. 1 shows a front view of an operating interface 100 according to a disclosed embodiment. FIG. 2 shows a corresponding side view of the operating element 100 from FIG. 1.

The operating interface 100 comprises a touch-sensitive display element 110 and at least one sensor 120. In the illustrative embodiment shown in FIGS. 1 and 2, the operating interface 100 has two sensors 120-1, 120-2, wherein the sensor 120-2 is designed as part of the touch-sensitive display element 110. However, in other disclosed embodiments, a larger or a smaller number of sensors 120 may, where relevant, also be implemented. These sensors, together with the touch-sensitive display element 110, are designed to perform the functions described below in combination with a control circuit 130 of the operating interface 100.

For this purpose, the sensor(s) 120 and the touch-sensitive display element 110 are coupled with the control circuit 130 in such a way that information-carrying signals can be exchanged between them. These signals may, for example, be electrical, optical or other signals which, for example, can be transmitted via individual lines or via data buses or a combination thereof. The relevant signals exchanged between the components may be designed discretely or continuously, and independently from one another both in terms of their signal strengths and also in terms of their variation over time. Analog signals, for example, but also digital signals can thus be exchanged between the components concerned.

The sensors 100 can thus, for example, forward corresponding sensor signals to the control circuit 130. The same may also apply, where relevant, to the touch-sensitive display element 110. In addition, the control circuit 130 can also forward control signals to the touch-sensitive display element 110 and, where relevant, to the sensors 120.

Whereas the touch-sensitive display element 110 is designed to display information to a user not shown in FIGS. 1 and 2, the sensors 120 are designed, where relevant, together with the display element 110 to perform various functions which will be described in detail below.

To provide the user with a display of the aforementioned information, the touch-sensitive display element 110 has a display surface 140 which may, for example, be a matrix-based display surface which enables a single-color and/or multicolor presentation of information, objects and other structures.

The sensors 120 and the touch-sensitive display element 110 are, on the other hand, designed to register a touch of the display element 110, i.e., for example, of the display surface 140 with a touch element 150 which may, for example, be a finger 160, a part of the finger or a different part of a hand of the user. If the touch-sensitive display element 110 or a corresponding sensor 120, for example the sensor 120-2 integrated into the touch-sensitive display element 110, detects a touch of this type, the display element 110 or the sensor 120 can forward a corresponding sensor signal to the control circuit 130. The latter can then trigger or perform a specific action, insofar as this corresponds to a previously defined set of rules or conditions, which, for example, may depend in a context-sensitive manner on the information presented on the display surface 140. The user can thus, for example, touch a virtual operating element with the touch element 150, whereupon the control circuit 130 performs a function allocated to the virtual operating element concerned or causes the function by outputting or forwarding a corresponding control signal.

Along with the finger 160 or a part thereof, the sensors 120 and/or the touch-sensitive display element 110 can also be designed in such a way that they detect a different part of the hand of the user as the touch element 150, by means of which the triggering or performance of an action can be caused by a touch of the display element 110 with the touch element 150.

The sensors 120 and the touch-sensitive display element 110 are furthermore designed in such a way that they register a presence of the touch element 150 in a detection area 170, which is drawn as a dotted line in FIGS. 1 and 2 and is adjacent to a side of the display element 110 facing toward the user. In the illustrative embodiment shown here, the detection area 170 is immediately adjacent to the display surface 140 of the display element 110. The detection area 170 is designed here so that it essentially completely surrounds the display element 110 or its display surface 140 in such a way that the touch element 150 must pass through the detection area 170 when the user guides or moves the touch element 150 toward the display element 110. The detection area thus extends from the display surface 140 or the display element 110 vertically in relation to the latter into a space which faces toward the user. The detection area thus represents a volume of the space.

If the control circuit 130 then detects that the touch element 150 is located in the detection area 170 during a predefined time period, but without a touch of the display element 110, i.e., for example, the display surface 140, having been registered during the time period, the control circuit can control the display element 110 so that information facilitating operation of the operating interface is displayed or presented on the display element 110. For this purpose, the control circuit 130 may, for example, measure a time period during which the touch element 150 is located in the detection area 170. If this measured time period is equal to or exceeds the predefined time period, the control circuit 130 can infer therefrom that the user is unsure regarding the operation of the operating interface if no touch of the display element by the user occurs in this time period. Depending on the implementation and application, the predefined time period may, for example, be at least 3 s, at least 5 s, at least 8 s, at least 10 s or at least 15 s. In particular, it may optionally be independent from a movement of the touch element 150 in or through the detection area 170.

The sensors 120 may be implemented here, for example, as resistive sensors, capacitive sensors, optical sensors or ultrasound-based sensors, by means of which a touch of the display element 110 with the touch element 150 or a proximity thereof, i.e. a presence of the touch element 150 in the detection area 170, can be registered. Heat sensors which make use of a heat radiation of a finger 160 or a different part of the human hand to detect a proximity of the hand, the finger 160 and, where relevant, also a touch thereof on the display element 110 may, where relevant, also be used.

In the case of capacitive sensors, those sensors, for example, in which a high frequency field is employed between the user and the display element can thus be used, the signal strength and/or phase relationship of which depends on a distance between the user, i.e. in particular his finger 160 or his hand, and the display element 110. If different frequencies are used, for example in motor vehicles, for drivers and front seat passengers and, where relevant, further passengers, the control circuit 130 can thus also detect, for example, which user operates the display element 110.

Optical sensors can also be used which also include, for example, camera-based systems. Alternatively or additionally, in the case of optical sensors, as well as the aforementioned heat-radiation-based sensors, i.e., for example, infrared sensors, sensors can also be used in which signals from light-emitting diodes are detected and are checked, for example, for an interruption, a reflection or other radiation changes. The same applies to ultrasound-based systems also.

At least one of the sensors 120 can thus, where relevant, be implemented as a proximity sensor, which, in connection with an operating interface 100 according to a disclosed embodiment, is therefore also referred to as an operating interface with a one-stage, two-stage or multi-stage proximity sensor system.

If the hand of the user thus activates the proximity sensor system and has been located in the detection area 170, also referred to as the trigger area, for 3, 5, 8, 10 or 15 s without a touch of the display element 110 (touch event) having taken place, information facilitating the operation of the operating interface 100 can be presented via the control circuit 130 on the display element 110. Thus, a help menu and/or a help display for operating the operating interface 100, which is also referred to as a touchscreen, can then be presented, for example, on the display surface 140. A corresponding presentation can thus be selected, for example as a help menu or help display, in which, for example, individual virtual operating elements are explained or clarified in terms of their functionality. Pop-up help windows, for example, can thus be implemented, by means of which an operation of the operating interface 100 can, where relevant, be facilitated. New context-related help menus can, where relevant, also be shown, via which an operation of the operating interface can, where relevant, also be designed as simpler and more intuitive.

Alternatively or additionally, the operating interface 100 and the control circuit 130 can also be designed so that if, for example, a hand of the user has activated the proximity sensor system (sensors 120) and has been located, for example, for 3, 5, 8, 10 or 15 s in the detection area 170 without a touch of the display element 110 having taken place, the operable virtual operating elements can be highlighted even more clearly on the display surface 140, which is also referred to as a monitor, screen or display, in that, for example, bolder lines, a larger presentation, a three-dimensional presentation, an enhanced three-dimensional presentation, an animation, additional shadows, luminous effects (glow), a higher contrast, stronger colors or a photorealistic presentation are used.

It may obviously be advisable, where relevant, to increase acceptance by a user of a system of this type, to design the display of the information facilitating the operation of the operating interface 100 on the display element 110 as activatable or deactivatable. Thus, for example, a corresponding help display in a settings menu can be designed as deactivatable.

Operating interfaces 100 according to a disclosed embodiment can be used here in a multiplicity of fields of application. They can be used, for example, in motor vehicles to operate integrated multi-function systems there which may, for example, comprise a navigation system, an entertainment system (infotainment system), a data exchange system by means of which, for example, data relating to a mobile radio connection to the Internet can be exchanged, and also systems for climate control and other vehicle-related systems. Illustrative embodiments of an operating interface 100 can thus be implemented, for example, as a touchscreen infotainment system with a one-stage proximity sensor system, as shown in connection with FIGS. 1 and 2, but also, where relevant, with a two-stage or multi-stage proximity sensor system.

However, illustrative embodiments of an operating system can similarly be put to use in other electrical and electronic components which include, for example, systems in the home, for example entertainment systems (home entertainment).

Obviously, not all of the designs and features described above need to be implemented in disclosed embodiments of an operating interface 100 according to a disclosed embodiment. Thus, for example, a design can be configured differently in terms of the geometric arrangement of the detection area 170 in relation to the display element 110 or the display surface 140. Similarly, the control circuit may differ from the embodiments described above in terms of the definition of the predefined time period. Where relevant, a deactivation facility of the information facilitating the display of the operation as an optional component can also be dispensed with.

Last but not least, in terms of the number and type of the sensors used, which may be implemented in part in the display element 110, some operating interfaces 100 according to a disclosed embodiment may differ from others. Thus, the sensors 120 can be implemented completely or partially as part of the touch-sensitive display elements 110. Additionally or alternatively, however, external sensors 120 which enable the previously described functions can also be used.

In the illustrative embodiment of an operating interface 100 shown in FIGS. 1 and 2, a time or time period, for example, can therefore be measured in which the hand, the finger 160 or a different touch element 150 is located in the detection area 170. The time during which the hand, the finger 160 or the touch element 150 does not touch the display element 110, i.e. the touchscreen, but is located in the detection area 170, is relevant here. Corresponding information can thus be presented depending on a proximity of the touch element 150 in the absence of a touch.

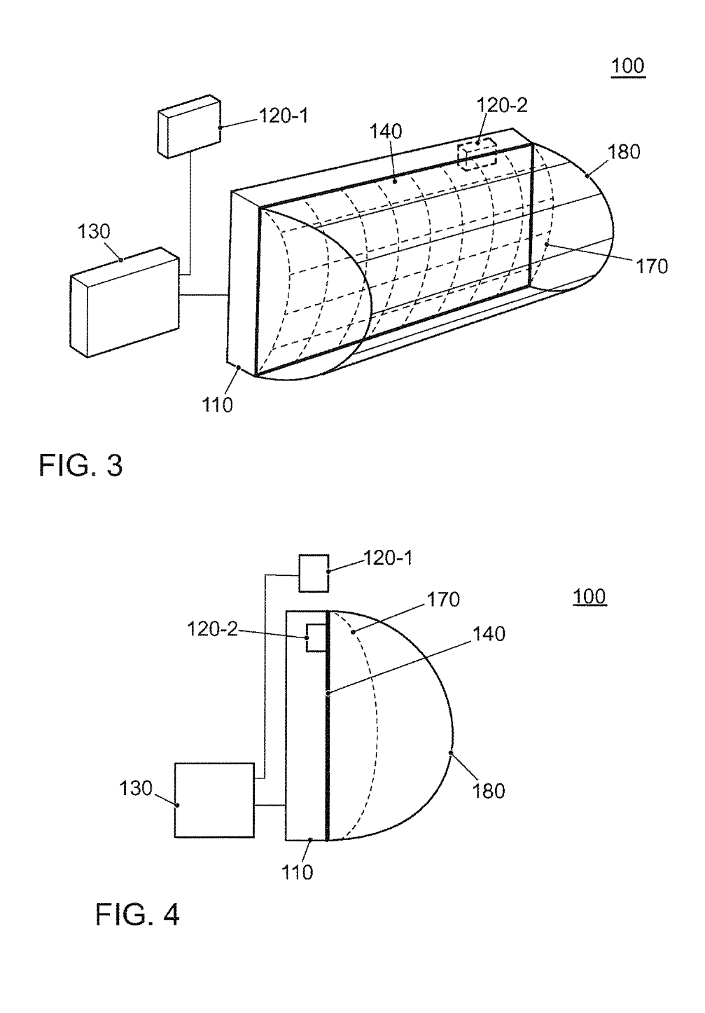

FIG. 3 shows a schematically simplified block diagram of a further disclosed embodiment of an operating system 100 in a perspective view, which differs from the operating interface 100 shown in FIGS. 1 and 2 essentially in terms of the design of the detection area 170 and a further detection area 180. To illustrate this difference more clearly, a perspective view of the operating interface 100 has been selected in FIG. 3, whereas FIG. 4 shows a side view of the operating interface 100 similar to FIG. 2.

The operating interface 100 shown in FIGS. 3 and 4 differs from that previously described essentially in that, along with the detection area 170 which, in the present case, is designed as spatially smaller than was previously the case in a disclosed embodiment, a further detection area 180 is now implemented. The further detection area 180 adjoins the detection area 170 on a side thereof facing toward the user. Here also, the further detection area 180 can be immediately adjacent to the detection area 170 and can optionally be designed so that it essentially completely surrounds the detection area so that the touch element 150, which is not shown in FIGS. 3 and 4, can only reach the detection area 170 if it first passes or moves through the further detection area 180. In other words, the further detection area 180 can essentially completely surround the detection area 170 in such a way that the touch element 150 (not shown in FIGS. 3 and 4) passes through the further detection area 180 if the user moves the touch element 150 into the detection area 170.

In such a case, the control circuit 130 can furthermore be designed so that it controls the display element 110 or the display surface 140 in such a way that it uses a modified presentation of the information shown on the display element 110 if the touch element 150 is located in the further detection area 180 and/or the detection area 170 during a further predefined time period without a touch of the display element 110 being registered during this time. The control circuit 130 can thus display further information facilitating the operation of the operating system 100 on the display element 110 or its display surface 140. For this purpose, the control circuit 130 can be designed accordingly to measure a time period during which the touch element 150 is located in the further detection area 180 or in the detection area 170. Here, the control circuit 130 can optionally also check only the further detection area 180 during the display of the further information.

The further detection area 180 can also extend, for example, from the display element 110 or its display surface 140 from a few centimeters to a few tens of centimeters toward the side facing toward the user. The further detection area 180 can thus, for example, have a boundary which faces toward the user and has a distance from the display surface 140 or the display element 110 of, for example, 5 to 50 cm, i.e., for example, of around 20 cm.

In contrast to this, the detection area 170 may extend less toward the user from the display element 110 or its display surface 140. It may thus, for example, extend no more than 10 cm toward the user. A boundary of the detection area 170 which faces toward the user and simultaneously represents a boundary of the further detection area 180 can thus, for example, have a distance from the display element 110 or the display surface 140 of around 5 cm.

The at least one sensor 120 and the touch-sensitive display element 110 can furthermore be designed accordingly to register also the presence of the touch element 150 in the further detection area 180 and forward it via a corresponding signal to the control circuit 130. As has already been explained, the further detection area 180 adjoins the detection area 170 here on a side facing toward the user.

The further time period during which the touch element 150 remains in the further detection area 180 without this resulting in a registration of a touch of the display element 110, can in turn, for example, be at least two 3 s, at least 5 s, at least 8 s, at least 10 s or at least 15 s. Here also, the further predefined time period may accordingly be independent from a movement of the touch element 150 in or through the further detection area 180.

If the control circuit then detects that the operating element 150 has been located in the further detection area 180 during the predefined further time period, but without resulting in a touch of the display element 110, it can control the display element 110 so that it displays further information facilitating the operation of the operating interface 100 on the display element 110. Here also, this may in turn comprise, for example, a subtle highlighting of at least one virtual operating element presented on the display element or a presentation or display of the help menu or a further help menu and/or the help display and/or a further help display.

The modification of the display may obviously, where relevant, also be designed as an optional component to be activatable or deactivatable.

FIGS. 3 and 4 therefore show an illustrative embodiment of an operating interface 100 according to a disclosed embodiment in which a two-stage proximity sensor system is implemented by means of the sensors 120. If the hand of the user activates the proximity sensor system and has been located for 3, 5, 8, 10 or 15 s in the first trigger area (further detection area 180) or the second trigger area (detection area 170) without a touch of the display element 110 (touch event) having taken place, the previously mentioned further help menu or help menu, for example, for the operation of the operating interface 100 can be shown on the display surface 140. Additionally or alternatively, virtual operating elements which are presented on the display element 110 may, for example, be subtly visually highlighted in connection with the modification of the presentation on the display element 110.

If, for example, a two-stage proximity sensor system is thus implemented, three different display variants, for example, can be implemented for one virtual operating element. If the touch element 150, for example, is not located either in the detection area or in the further detection area 180, i.e. has distanced itself, the virtual operating element concerned may, for example, be shown as small and without a border, as a two-dimensional presentation. A graphical presentation may also, where relevant, be completely dispensed with or its transparency can be set to 100%. If the touch element 150 then approaches from the distant state so that, in a first stage, it enters the further detection area 180, the virtual operating element can be presented, for example, as larger and/or with a frame, but a three-dimensional presentation may also be used and/or may have a corresponding filling. If the touch element enters the detection area 170 and pauses there for the corresponding time period, the virtual operating element may, where relevant, be presented as even larger, with a thicker frame in a three-dimensional presentation and/or with a filling and, where relevant, luminous effects (glow).

In the use of a two-stage proximity sensor system, a third stage, for example, of the display of operable elements can thus be implemented. As a result, not only can an operation of the system be designed, where relevant, as simpler and more intuitive, this can also be effected within a visually pleasing overall concept so that a presentation of the relevant information on the display surface 140 that is perceived as pleasant is possible. The use of a proximity sensor system of this type can thus, for example, enable a simpler and more intuitive operability with a simultaneously pleasing design in the distanced state, as previously described.

This implementation can obviously also be designed as deactivatable to thus improve acceptance by the user. The third display may thus, for example, be deactivatable in a settings menu. In other words, in a disclosed embodiment of an operating interface, the control circuit can optionally be designed to make the use of the modified presentation of the information shown on the display element deactivatable.

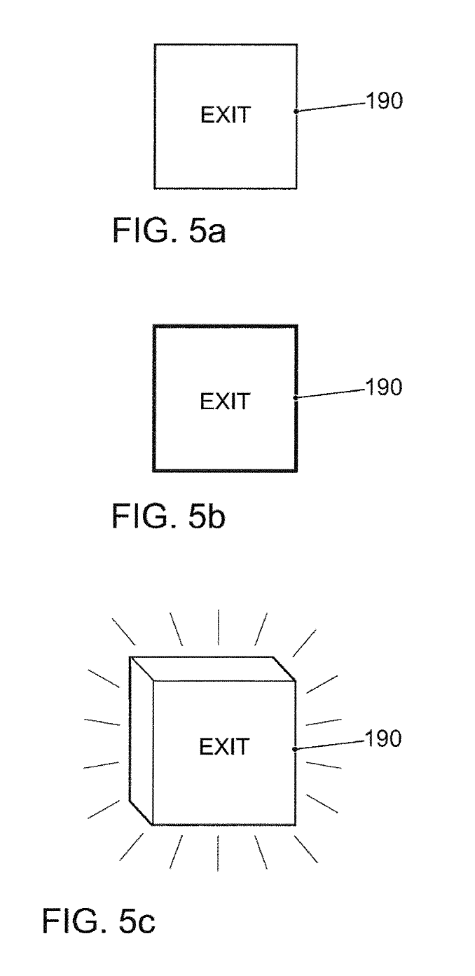

FIG. 5a thus shows a virtual operating element 190 which may, for example, be a virtual touch area, which is also referred to as a button. Here, FIG. 5a shows, for example, a state in which the touch element 150 is not present in one of the detection areas 170, 180 or has not yet exceeded the predefined time period or predefined further time period.

If the touch element 150 is located in the further detection area 180 for longer than the predefined further time period, the control circuit can modify the presentation of information shown on the display element 110 in such a way that the virtual operating element 190 is more clearly highlighted through the use of thicker lines, as shown, for example, in FIG. 5b.

If on the other hand, the touch element 150 is present in the detection area 170 for more than the predefined time period without this resulting in a touch of the display element 110, the control circuit 130 can control the display element 110 in such a way that the virtual operating element 190 is presented, for example, three-dimensionally with a corresponding luminous effect around its edge. In addition, a font size of the labelling of the virtual operating element 190 can be increased, as shown in FIG. 5c.

The virtual operating elements 190 in FIGS. 5a and 5b thus show identically large “EXIT” labels, whereas, in FIG. 5c, the presentation of the word “EXIT” is enlarged, i.e. with a correspondingly larger font size. The highlights described and labels used are obviously individual examples only.

Other modifications can obviously also be made to the presentation of information shown on the display element 110 or a display of corresponding information facilitating operation of the operating interface on the display element 110.

Equally, not all of the previously described designs in other disclosed embodiments need to be implemented in connection with the illustrative embodiment shown in FIGS. 3 and 4. Differences, for example in terms of the geometric arrangement of the detection areas 170, 180, to name but one example, can, where relevant, be implemented here also.

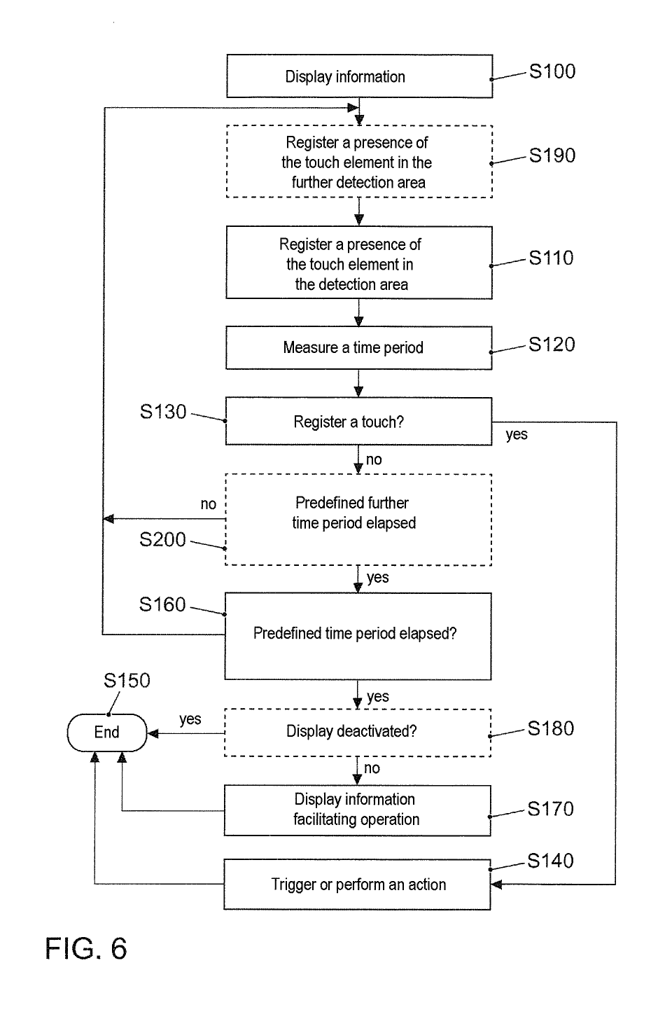

Finally, FIG. 6 shows a flow diagram of a method for displaying information facilitating operation of an operating interface 100. First, in a step S100, information is shown on the display element 110 or the display surface 140. In a step S110, an attempt is then made to register a presence of the touch element 150 in the detection area 170. In a step S120, a time period is measured accordingly for this purpose. In a step S130, an attempt is made to register a touch. If such a touch is registered here, the action associated with the touch is triggered or performed in a step S140, before the method ends in a step S150.

However, if no touch is registered in step S130, a check is carried out in a step 160, to ascertain whether the predefined time period has elapsed. If so, in a step S170, information facilitating the operation of the operating interface 100 is presented on the display element 110, before the method again ends in step S150. If not, however, i.e. if the predefined time period has not yet elapsed, a return can be effected to after step S100 of displaying the information, so that once more, for example, a presence of the touch element in the detection area 170 is registered, the time period is measured and a check for the occurrence of a touch can again be carried out.

Optionally, in a step S180 between the check to determine whether the predefined time period has elapsed (step S160) and the display of the information in step S170, a check can obviously be carried out to determine whether the display is deactivated. If not, a corresponding display of the information can be effected in step S170, otherwise the method can be ended in step S150.

The previously described method is such that it can be implemented, for example, by means of a one-stage proximity sensor. However, as previously described in connection with FIG. 6, this method can also be implemented in a two-stage sensor. Additionally, however, it may furthermore comprise a registration of a presence of the touch element in the further detection area 180 in a step S190, which can be carried out, for example, after a display of the information on the display element in step S100. Similarly, in a step S200, a check can be carried out to determine whether the predefined further time period has elapsed without a touch having been registered. Step S200 can thus, for example, be carried out after step S130 of checking to determine whether a touch has been registered. If it is established, in the check to determine whether the predefined further time period has elapsed, that this is the case, the presentation of information on the display element 110 can also be modified or the further information facilitating the operation of the operating interface 100 can be shown in step S170 directly or indirectly after the performance, for example, of steps S160 and S180. If not, however, a return can be effected to a step after the display of the information on the display element 110 in step S100.

In illustrative embodiments of a method of this type, the steps described may obviously differ from one another in terms of their sequence, in that they are carried out, where relevant, in parallel with or temporally overlapping one another, unless otherwise indicated in the description.

An operation of the system which comprises an operating interface 100 of this type may, where relevant, be designed as simpler and more intuitive through the use of a disclosed embodiment.

The features disclosed in the above description, the following claims and the attached figures may be of importance and may be implemented in their different designs both individually and in any given combination for the realization of a disclosed embodiment.

Although some aspects have been described in connection with a device, it is obvious that these aspects also represent a description of the corresponding method, so that a block or component of the device can also be understood as a corresponding method step or as a feature of a method step. By the same token, aspects that have been described in connection with or as a method step also represent a description of a corresponding block or detail or feature of a corresponding device.

Depending on specific implementation requirements, illustrative embodiments can be implemented in hardware and software. The implementation can be carried out using a digital storage medium, for example a floppy disk, a DVD, a Blu-ray disc, a CD, a ROM, a PROM, an EPROM, an EEPROM or a FLASH memory, a hard disk or a different magnetic or optical storage device on which electronically readable control signals are stored which can interact or do interact with a programmable hardware component in such a way that the respective method is carried out.

A programmable hardware component may be formed by a processor, a Central Processing Unit (CPU), Graphics Processing Unit (GPU), a computer, a computer system, an Application-Specific Integrated Circuit (ASIC), an Integrated Circuit (IC), a System On Chip (SOC), a programmable logic element or Field Programmable Gate Array (FPGA).

The digital storage medium can therefore be machine-readable or computer-readable. Some illustrative embodiments therefore comprise a data medium which has electronically readable control signals which are capable of interworking with a programmable computer system or a programmable hardware component in such a way that one of the methods described herein can be carried out. An illustrative embodiment is therefore a data medium (or a digital storage medium or computer-readable medium) on which the program to carry out one of the methods described herein is recorded.

Illustrative embodiments can generally be implemented as a program, firmware, computer program or computer program product with a program code, or as data, wherein the program code or the data is/are effective in carrying out one of the methods when the program runs on a processor or on a programmable hardware component. The program code or data may, for example, also be stored on a machine-readable medium or data medium. The program code or data may occur, inter alia, as source code, machine code or byte code, or as a different intermediate code.

One further disclosed embodiment is moreover a data stream, a signal sequence or a series of signals representing the program for carrying out one of the methods described herein. The data stream, signal sequence or series of signals may, for example, be configured in such a way that they can be transferred via a data communication connection, for example via the Internet or a different network. Illustrative embodiments therefore also comprise signal sequences representing data which are suitable for a transfer via a network or data communication connection, wherein the data represent the program.

A program according to a disclosed embodiment can carry out one of the methods during its execution, for example, in that the program reads out memory locations or writes a datum or a plurality of data thereto, as a result of which, where relevant, switching processes or other processes in transistor structures, in amplifier structures or in other electrical, optical, magnetic components or components operating according to a different functional principle are invoked. Data, values, sensor values or other information can accordingly be captured, determined, or measured by a program by means of a read-out of a memory location. A program can therefore capture, determine or measure parameters, values, measured values or other information by means of a read-out from one or more memory locations, and can also effect, instigate or perform an action by means of a writing to one or more memory locations, and can also control other devices, machines and components.

The illustrative embodiments described above merely represent an illustration of the principles of the present invention. Modifications and variations of the arrangements and details described herein will be apparent to other persons skilled in the art. It is therefore intended that the invention be restricted only by the protective scope of the following patent claims and not by the specific details that have been presented herein by means of the description and the explanation of the disclosed embodiments.

The functionality of electrical and electronic components is constantly increasing in many fields of technology. Examples of this include home entertainment systems, and also multi-function systems of the type used, for example, in motor vehicles. Multi-function systems of this type may comprise, for example, functions of a navigation system, an entertainment system, a system for data networking and also the air-conditioning components of the vehicle and other vehicle-specific components.

To enable a user of these systems to operate the systems as simply and intuitively as possible, touch-sensitive display elements, which are also referred to as touchscreens, are frequently used today. Information, which may comprise, for example, virtual operating elements and other components which the user can select or activate by touching them, can be presented in a context-sensitive manner on the screens.

Multimedia information and control systems of this type are known, for example, from EP 0 956 219 B1 and DE 10 2009 059 867 A1. The last-named document thus describes, for example, a method and a device for providing a graphical user interface which enables objects presented on a display surface to be moved by means of a gesture.

However, contactless display and operating devices via which a corresponding selection is possible are also used in a motor vehicle. Thus, for example, DE 10 2007 029 618 A1 describes a display and operating device which can be activated in a contactless manner and which can be operated in different operating modes.

However, in these and in similar systems, it may occur that a multiplicity of different information elements are made available simultaneously to a user. Along with virtual operating elements, i.e., for example, virtual buttons and virtual sliders or dials, information elements which in fact enable no interaction with the user are also frequently displayed here. The information elements could include, for example, backgrounds, but also, for example, map presentations and other information and objects.

With an increasing number of available functions of a system of this type, operation of the system may, where relevant, present the user with considerable challenges. These challenges may, where relevant, be exacerbated in some instances if the system concerned is used in an environment in which the user's attention is not devoted unrestrictedly to the system. In the case of a motor vehicle, this may, for example, be the case when the user is the driver of the motor vehicle and the driver must simultaneously pay attention to the environment and the traffic situation during the journey.

A need therefore exists to design the operation of a system of this type to be simpler and more intuitive.

An operating interface, a method for displaying information facilitating operation of an operating interface and a program with a program code to carry out a method of this type as take this requirement into account.

### REFERENCE NUMBER LIST

100 Operating interface

110 Touch-sensitive display element

120 Sensor

130 Control circuit

140 Display surface

150 Touch element

160 Finger

170 Detection area

180 Further detection area

190 Virtual operating element

S100 Display information

S110 Register a presence in the detection area

S120 Measure a time period

S130 Register a touch?

S140 Trigger or perform an action

S150 End

S160 Predefined time period elapsed?

S170 Display information or modify presentation

S180 Display deactivated?

S190 Register a presence in the further detection area

S200 Predefined further time period elapsed

1. An operating interface comprising:
a touch-sensitive display element and at least one sensor designed to display information on the display element to a user to register a touch of the display element with a touch element by the user and to register a presence of the touch element in a detection area, wherein the detection area is adjacent to a side of the display element facing toward the user; and
a control circuit designed to control the display element so that the display element presents information on the display element facilitating operation of the operating interface if the touch element is located in the detection area during a predefined time period without a touch of the display element having been registered during the time period.

2. The operating interface of claim 1, wherein the touch-sensitive display element and the at least one sensor are designed so that the detection area surrounds the touch-sensitive display element completely so that the touch element must pass through the detection area when the user moves the touch element toward the touch-sensitive display element.

3. The operating interface of claim 1, wherein the predefined time period is at least 3 s.

4. The operating interface of claim 1, wherein the predefined time period of is independent from a movement of the touch element in or through the detection area.

5. The operating interface of claim 1, wherein the control circuit controls the display element so that the display of the information facilitating the operation comprises a visual highlighting of at least one virtual operating element and/or presented on the display element a presentation of a help menu and/or a help display.

6. The operating interface of claim 1, wherein the control circuit makes the presentation of the information facilitating the operation of the operating interface deactivatable.

7. The operating interface of claim 1, wherein the touch-sensitive display element and the at least one sensor register a presence of the touch element in a further detection area, wherein the further detection area is adjacent to the detection area on a side facing toward the user, and wherein the control circuit controls the display element so that the latter presents further information facilitating the operation of the operating interface if the touch element is located in the further detection area and in the detection area during a further predefined time period without a touch of the display element having been registered during this time period.

8. The operating interface of claim 7, wherein the touch-sensitive display element and the at least one sensor are designed so that the further detection area essentially completely surrounds the detection area so that the touch element passes through the further detection area when the user moves the touch element into the detection area.

9. The operating interface of claim 7, wherein the further predefined time period is at least 3 s.

10. The operating interface of claim 7, wherein the further predefined time period is independent from a movement of the touch element in or through the further detection area.

11. The operating interface of claim 7, wherein the control circuit controls the display element so that the display of the further information facilitating the operation of the operating interface comprises a subtle highlighting of at least one virtual operating element presented on the display element, and/or a presentation of a help menu and/or a help display.

12. The operating interface of claim 1, wherein the touch-sensitive display element and the at least one sensor are designed so that the touch element comprises at least a part of a finger and/or at least a part of a hand.

13. A method for displaying information facilitating operation of an operating interface, the method comprising:
displaying information on a touch-sensitive display element of the operating interface;
registering a presence of a touch element in a detection area, wherein the detection area is adjacent to a side of the display element facing toward the user; and
presenting the information facilitating the operation of the operating interface if the touch element is located in the detection area during a predefined time period without a touch of the display element having been registered during said time period.

14. The method of claim 13, further comprising registering a touch of the touch-sensitive display element with the touch element by the user.

15. A program with a program code to carry out the method of 13 when the program code is executed on a computer, a processor or a programmable hardware component.

16. The operating interface of claim 5, wherein the visual highlighting includes at least one of a display of an edge of the at least one virtual operating element with thicker and/or color-highlighted lines, a color-highlighted display of the at least one virtual operating element, an enlarged display of the at least one virtual operating element, a display of the at least one virtual operating element in a three-dimensional or enhanced three-dimensional presentation, a pulsating display of the at least one virtual operating element, a display of the at least one virtual operating element with a luminous effect surrounding the edge of the at least one virtual operating element.

17. The operating interface of claim 7, wherein the visual highlighting includes at least one of a display of an edge of the at least one virtual operating element with thicker and/or color-highlighted lines, a color-highlighted display of the at least one virtual operating element, an enlarged display of the at least one virtual operating element, a display of the at least one virtual operating element in a three-dimensional or enhanced three-dimensional presentation, a pulsating display of the at least one virtual operating element, a display of the at least one virtual operating element with a luminous effect surrounding the edge of the at least one virtual operating element.
